(19) United States
(12) Patent Application Publication
(10) Pub. No.: US 2012/0329003 A1
(43) Pub. Date: Dec. 27, 2012

(54) ARTICULATOR

(76) Inventors: Chae Bung Lee, Gyeongju-si (KR); Se Hun Kim, Jeonju-si (KR)

(21) Appl. No.: 13/582,987

(22) PCT Filed: Apr. 16, 2010
(86) PCT No.: PCT/KR2010/002400

§ 371 Date: Sep. 5, 2012

(30) Foreign Application Priority Data
Mar. 5, 2010 (KR) 10-2010-0019932

(51) Int. Cl. A61C 11/00

(52) U.S. Cl. 433/54

(57) ABSTRACT

The present invention relates to an articulator for the purpose of checking the alignment of dentures, by coupling together models of the upper and a lower jaws, in order to provide a simple movement of the upper and lower jaws, minimize occlusal errors, and accurately mount the upper and lower jaws onto the occlusion surface. Conventional articulators imitate the form of upper and lower jaw movements, wherein a reference axis is established and folded in accordance with a condyle, however, the process completely eliminates muscle movement, and inevitably leads to occlusal errors during upper and lower jaw movement. Consequently, the problem with conventional articulators is the need for post-processing, regardless of the extent of reduction of the occlusal errors through the use of diverse assisting means. In addition, while accurate occlusion cannot be achieved, conventional articulators have a structure that is too complicated and difficult to operate. Therefore, in the present invention, a reference axis is formed on a line extending from the central plane of an upper jaw mounting plate and a lower jaw mounting plate, so that the tangent of rotation creates a vertical motion on the occlusion surface, which allows upward and downward movements that are closer to physiological movements than conventional assisting means, which require making fine adjustments to occlusion, minimizes the margin of error of the articulator, and provides a simple operating structure for the upper and the lower jaw mounting plates and an easier usage thereof.

### TECHNICAL FIELD

The present invention relates to an articulator which makes it possible to check an arranging relationship of teeth in such a way to attach upper and lower jaw models, and particularly to an articulator which makes it possible to minimize an articulating error and to mount accurately an upper jaw and a lower jaw on an articulating surface while ensuring a simple motion mechanism of an upper jaw and a lower jaw.

### BACKGROUND ART

An articulator is a device generally used for the sake of a manufacture and diagnosis of denture, tooth crown restoration, prosthetic appliance, etc. by measuring a coupled state of teeth and a gum and is configured to mechanically imitate and reproduce a relative position relationship of a jawbone and teeth with respect to a cranium and the motions of a low jaw.

The upper and low jaw motions of a human being's body come as a lower jaw bone moves with an upper jaw bone not moving, so most of the articulators are designed imitating the motions of the upper and low jaw bones. A reference axis where an upper jaw mounting plate and a low jaw mounting plate are folded is formed about a condylar.

In addition, an articulator used to manufacture a prosthetic appliance has a number of types ranging from a plain line articulator reproducing only one lower jaw, an adjustable articulator with a high reproduction rate, and a free motion articulator.

As shown in FIGS. 22 and 23, the position of the reference axis is manufactured matching with the condylar in order to reproduce the motions of the lower jaw of a human being's body. Considering in terms of the anatomy of a human being's body, the condylar is formed in a spherical shape, so there is a lot of differences from the operation principles of the axis. In addition, the upward and downward motions of the teeth are generally conducted in a combination with the position of the condylar and the motions of muscles (masticatory muscle). When considering only the position of the condylar as a reference axis, the motions of the muscles are eliminated from considerations, so errors inevitably occur when measuring the motions of the upper and lower jaws.

When trying to reduce the errors, the structure of the articulator is complicated, and it is needed to disassemble and mount and couple once again the upper jaw mounting plate and the lower jaw mounting plate using a separate tool in order to mount the upper jaw and low jaw model, which is hard to use, and when adjusting them downward or upward or the left and right width depending on a patient, the operation of the articulator is hard, and the manufacture costs a lot owing to the complicated structure of the articulator.

The conventional articulator is configured to fix the upper and lower jaw models while confirming the position of the articulating plane surface with the aid of an assistant means such as a rubber string, a laser, etc. in order to accurately position the upper and lower jaw models on the articulating plane surface; however using such means causes a lot of problems when mounting at a precise position, and a minor errors inevitably occurs owing to the thickness of to a rubber string or a laser itself.

Though it is adjusted to match with the mouth structure of a patient using the articulator, since the operations of the tools used to adjust the minor errors and the left and right width are manually performed, so minor errors are also inevitable. Even though it is very accurately adjusted, the thickness of an articulating sheet used to check the coupled state is actually very thin, it is almost impossible to manually adjust the error ranges, so a post-process is needed in a state that a patient has a prosthetic appliance.

### DISCLOSURE OF INVENTION

Accordingly, the present invention is provided to overcome the above described problems and it is an object of the present invention to provide an articulator which makes it possible to minimize the error ranges of an articulator in such a way to set the position with a reference axis which is the center of a biological articulation during the motions of upper and lower jaws, and the operation structures and uses of the upper jaw mounting plate and the lower jaw mounting plate of the articulator are simplified, and the upper jaw and lower jaw models are accurately positioned on the articulating plane surface for thereby obtaining an accurate articulation.

To achieve the above objects, there is provided an articulator in which an upper jaw mounting plate and a lower jaw mounting plate are detachable in one touch way in such a way to form a rotary shaft at the lower jaw mounting plate by forming a reference axis on an articulating plane surface on which the upper jaw mounting plate and the lower jaw mounting plate are folded and by enabling the tangent line of the rotation motion is formed in a vertical direction with respect to the articulating plane surface.

In addition, a jig is detachable in one touch way at the rotary shaft of the lower jaw mounting plate for the purpose of adjusting the horizontal state of the lower jaw model, so the upper and lower jaw models can be accurately positioned on the articulating plane surface, and a position shaft is formed at the jig for the purpose of fixing the lower jaw model not to move in a fixed state, thus obtaining an accurate articulating measurement.

Advantageous effects

The present invention makes it possible to minimize the error ranges of the articulator by defining as a reference axis the point which is the center of the biological articulation of teeth, which results in an accurate articulation, and the construction of such articulator is simplified, and the manufacture of it is easy, and the manufacture cost is low, and when mounting the upper jaw model and the lower jaw model when in use of the articulator, the upper jaw mounting plate can be easily detached without disassembling the articulator, so they can be easily mounted, which brings to obtaining easier use and reduced work time.

In addition, since the position of the articulating plane surface can be set using the jig, the error ranges of the articulation can be reduced more.

### BRIEF DESCRIPTION OF DRAWINGS

FIG. 1 is a perspective view illustrating an embodiment of the present invention.

FIG. 2 is a side view illustrating a folding structure of an articulator according to the present invention.

FIG. 3 is a schematic view illustrating a biological articulating state of an articulator according to the present invention.

FIG. 4 is a perspective view illustrating a detaching structure of a lower jaw mounting plate and an upper jaw mounting plate of the present invention.

FIG. 5 is a side cross sectional view illustrating a detaching structure of a lower jaw mounting plate and an upper jaw mounting plate according to the present invention.

FIG. 6 is a plane cross sectional view illustrating a distorted state of a rotary shaft and a rotation support part according to the present invention.

FIG. 7 is a side view of another embodiment of the rotation support part according to the present invention.

FIG. 8 is a side view illustrating an operation structure of a guide pin of an upper jaw mounting plate according to the present invention.

FIG. 9 is a perspective view illustrating an assembled structure of is an adjusting part of an upper jaw mounting plate according to the present invention.

FIG. 10 is a perspective view illustrating a state that a jig is coupled to a lower jaw mounting plate according to the present invention.

FIG. 11 is a perspective view illustrating a state that a jig is coupled according to the present invention.

FIGS. 12 to 14 are schematic views illustrating a mounting procedure of the upper jaw and lower jaw models.

FIG. 15 is a perspective view of another embodiment of the articulator according to the present invention.

FIGS. 16 and 19 are perspective views of another embodiment of a jig of the present invention.

FIGS. 17 and 18 are views of the states of use of a jig of FIG. 16.

FIGS. 20 and 21 are views of the states of use of a jig of FIG. 19.

FIG. 22 is a side view illustrating a folding structure of a to conventional articulator.

FIG. 23 is a schematic view illustrating a reference axis position of a conventional articulator.

### BEST MODES FOR CARRYING OUT THE INVENTION

The present invention is characterized in that a low jaw mounting plate 10 mounting a lower jaw model 100 and an upper jaw mounting plate 20 mounting an upper jaw model 200 are foldable upward and downward by means of a rotary shaft 11, and the columns 12 and 22 positioned behind the lower jaw mounting plate 10 and the upper jaw mounting plate 20 have the same lengths, so the rotary shaft 11 is extended on an extension line of the articulating plane surface (α), and the lower jaw mounting plate 10 and the upper jaw mounting plate 20 operate upward and downward about the rotary shaft 11 in a symmetrical way, and when the lower jaw model 100 and the upper jaw model 200 are folded upward and downward, the tangent line (β) of the rotational motion is vertical with respect to the articulating plane surface.

### Modes for Carrying out the Invention

Hereinafter the preferred embodiments of the present invention will be described with reference to the accompanying drawings. The same elements are assigned the same reference numerals in the drawings.

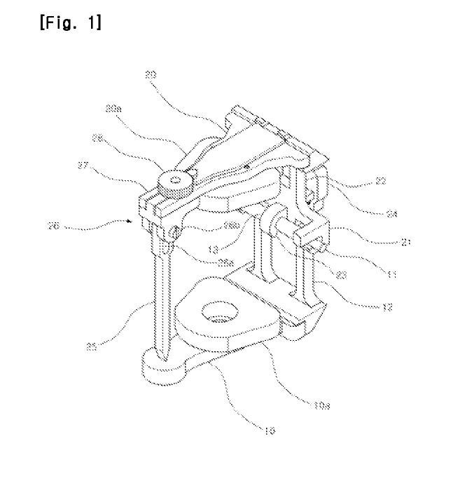

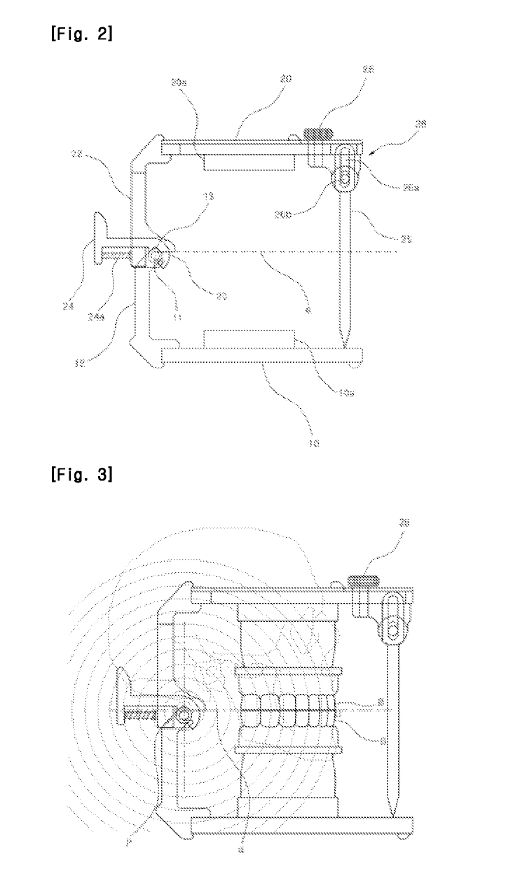

As shown in FIGS. 1 and 2, the present invention is characterized in that the lower jaw mounting plate 10 and the upper jaw mounting plate 20 can be folded upward and downward by means of a rotary shaft 11, and the horizontality of the upper jaw mounting plate 20 can be adjusted using the guide pin 25 formed at the front side of the upper jaw mounting plate 20, and the articulating plane surface (α) is set, and the lower jaw model 100 and the upper jaw model 200 are mounted on the thusly set articulating plane surface (α), thus checking the arranging state of the teeth.

The lower jaw model 100 and the upper jaw model 200 are mounted on the lower jaw mounting plate 10 and the upper jaw mounting plate 20, respectively, and the models 100 and 200 are mounted on the articulating plates 10a and 20a and are detachable.

At this time, the articulating plates 10a and 20a and the upper and lower jaw mounting plates 10 and 20 are configured to be detachable with the aid of a magnet.

To the rear sides of the lower jaw mounting plate 10 and the upper jaw mounting plate 20 are connected the rotary shaft 11 as the columns 12 and 22 are vertically upright. At this time, when the column 12 formed at the lower jaw mounting plate 10 and the column 22 formed at the upper jaw mounting plate 20 are configured to have the same lengths, the rotary shaft 11 is formed on the extension line of the articulating plane surface (α), so the lower jaw mounting plate 10 and the upper jaw mounting plate 20 operate symmetrically upward and downward about the rotary shaft 11. As shown in FIG. 3, as the tangent line (β) of the upper jaw model 100 and the lower jaw model 200 come is into contact with the articulating plane surface (α) in a vertical direction, they can be folded upward and downward about the point P which is the center of the biological articulating of teeth.

In other words, the upper jaw model 100 and the lower jaw model 200 are folded downward and upward about the reference point (P) of the rear side, so the motion structure of the upper and lower jaws operate in a vertical direction which is similar to the biological motions of teeth, whereby the error ranges of the articulator are minimized, and more accurate articulating is made possible.

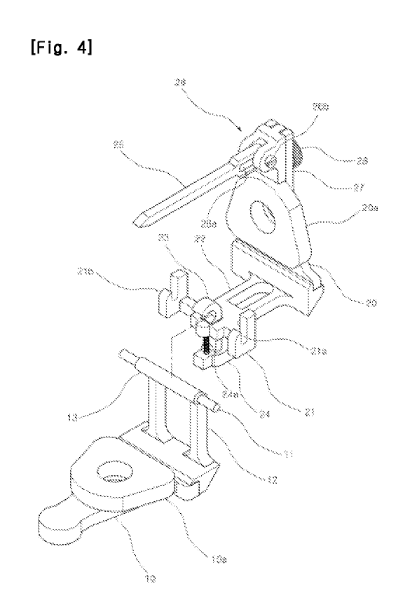

In addition, the construction that the lower jaw mounting plate 10 and the upper jaw mounting plate 20 are folded will be descried in more details with reference to the articulating structure of FIG. 4. The lower jaw mounting plate 10 is configured in such a way that a shaft 13 is formed at an upper side of the column 12 of the rear side, and a rotary shaft 11 is protruded from both sides of it, and the upper jaw mounting plate 20 is configured in such a way that to a laid-down channel shaped rotation support part 21 with an inner insertion groove 21a is formed at the lower side of the column 22, so the upper jaw mounting plate 20 can be folded upward and downward as it is axially coupled to the rotary shaft 11.

At this time, the upper jaw mounting plate 20 forms a hook 23 at a center between the rotation support parts 21 of both sides, so the hook 23 is caught on the shaft 13, and the upper jaw mounting plate 20 does not randomly disconnect in a state that it is caught on the lower jaw mounting plate 10, and the upper jaw mounting plate 20 can be configured to be rotatable, and the upper jaw mounting plate 20 can be detached from the lower jaw mounting plate 10. At the rear side of the hook 23 is formed a push switch 24, and the push switch 24 is configured to have a recovery force by means of a spring 24a, so the upper jaw mounting plate 20 can detach from the lower jaw mounting plate 10 in one touch way.

At this time, slope surfaces 23b and 21b are formed at the front side of the hook 23 and at the lower side of the rotation support part 21, and the slope surface 23b of the hook 23 fits as it slides along the upper surface of the shaft 13 when articulating the lower jaw mounting plate 10 and the upper jaw mounting plate 20, and the slope surface 21b of the rotation support part 21 fits as it slides along the upper surface of the rotary shaft 11 and is pressurized, so the forced fits of the lower jaw mounting plate 10 and the upper jaw mounting plate 20 can be made possible, which results in easier assembling.

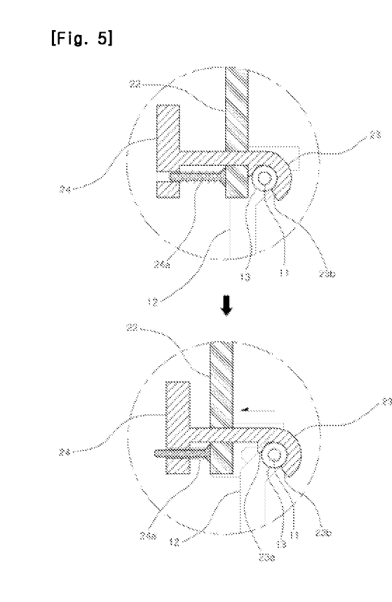

On the contrary, when it is needed to separate the upper jaw mounting plate 20, as shown in FIG. 5, when pushing the push button 24 in a state that the upper jaw mounting plate 20 is held, the pusher 23a protruded from the inner side of the hook 23 pushes forward the shaft 13, so the coupled state of the rotation support part 21 becomes released, whereby the upper jaw mounting plate 20 can be easily disconnected from the lower jaw mounting plate 10.

So, when mounting or dismounting the lower jaw model 100 and the upper jaw model 200, since it can be easily finished after the upper jaw mounting plate 20 is separated, the mounting can be down easily, and thanks to that the work time can be reduced.

The articulator according to the present invention is characterized in that the arranged state of the teeth can be checked by distorting left and right the lower jaw model 100 and the upper jaw model 200 after an articulating sheet is inserted into between the models when it is needed to check the coupled state of the upper and lower jaw models 100 and 200. As explained above, since the rotation support part 21 is formed in a laid-down channel shape, the frontward disconnection of the rotary shaft 11 is made possible, so the lower jaw mounting plate 10 and the upper jaw mounting plate 20 can be distorted left and right from the state that they are fixed by means of the hook 23.

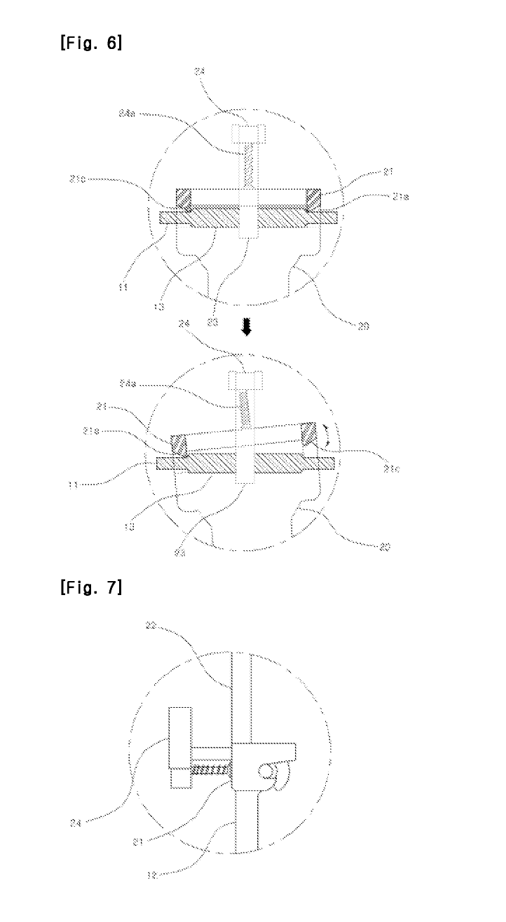

As shown in FIG. 6, the rotation support part 21 is characterized in that a slope 21c is outwardly formed at an inner end portion of the inner is insertion groove 21a, so the rotary shaft 11 is not interfered with the shoulder when distorting left and right the upper jaw mounting plate 20 for thereby easily distorting them left and right.

As shown in FIG. 7, the inner insertion groove 21a is configured to have a surface with a slope angle of −2°, it is possible to move with a very accurate control closer to the biological articulating of teeth when distorting left and right the upper jaw mounting plate 20, so the articulating measurement can be more accurately performed.

At this time, the reason that the slope angle is set at an angle of −2° lies in that the angle of the line connecting the point (P) which is the center of the biological articulating and the upper end portion of the front teeth is −2° from the virtual line, which is defined as a reference line, connecting the point (P) which is the center of the biological articulating in terms of human being's anatomical views and the cutting tooth point, so to match with the above mentioned angle, the upper surface of the inner insertion groove 21a is formed to have a slope angle of −2°, so the left and right distortions are performed closer to the physiological movement.

The work procedure of the above mentioned articulator will be described. The lower jaw model 100 is positioned on the top of the lower jaw mounting plate 10, and it is mounted using a plaster, and afterward the upper jaw model 200 is positioned at the lower side of the upper jaw mounting plate 20, and it is mounted using a plaster, and the lower jaw mounting plate 10 and the upper jaw mounting plate 20 are folded, and the coupled state is checked.

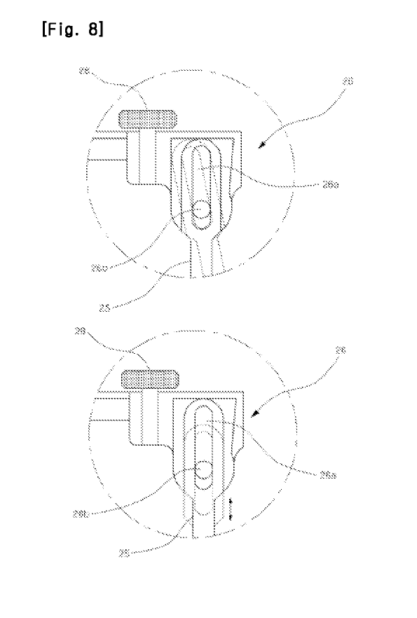

The upper jaw mounting plate 20 has a guide pin 25 at a front side of it, thus supporting the horizontal state of the upper jaw mounting plate 20, and as shown in FIG. 8, an adjusting means 26 is formed on the top of the guide pin 25, so the angle adjustment can be conducted in the forward and backward directions as the guide pin 25 moves upward and downward in a vertical direction.

For the sake of that, the adjusting means 26 is configured to facilitate the guide pin 25 to move vertically and to adjust the angle as a prolonged hole 26a is formed at the top of the guide pin 25, and the fixing shaft 26b fits the prolonged hole 26a.

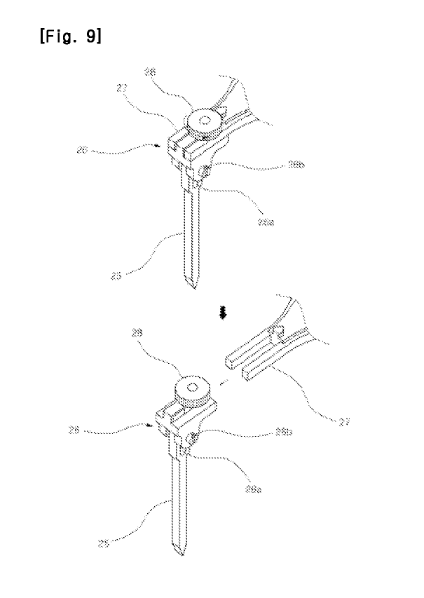

When the upper jaw mounting plate 20 is folded upward and downward, the positions of the guide pin 25 moves slightly forward and backward. In order to compensate it, as shown in FIG. 9, the adjusting means 26 is configured to couple with the guide rail 27 of the front side of the upper jaw mounting plate 20 in a rail structure, so the position compensation can be made possible as it can slide forward and backward.

At this time, the fixing of the guide pin 25 and the forward and backward motions of the adjusting means 26 are tightened using a tightening means 28, thus fixing in place and it is preferable that scales are formed at the operation portions of the guide pin 25 and the adjusting means 26 for the sake of articulating in place.

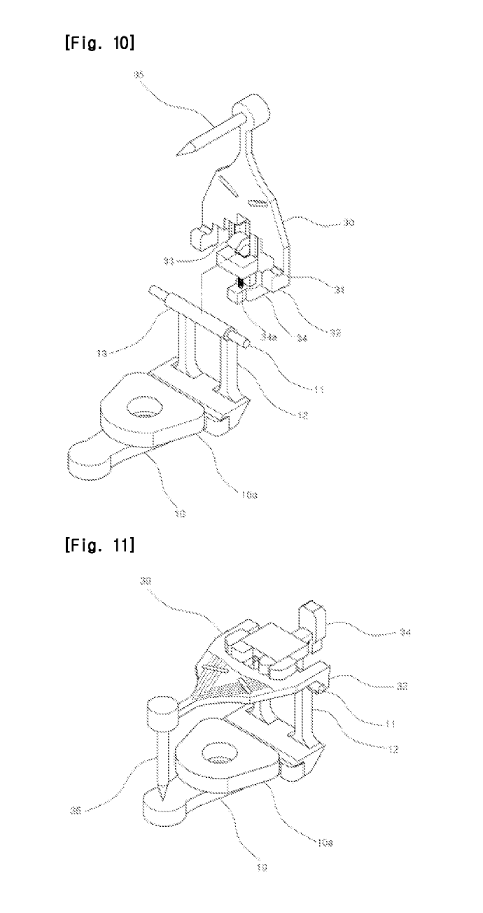

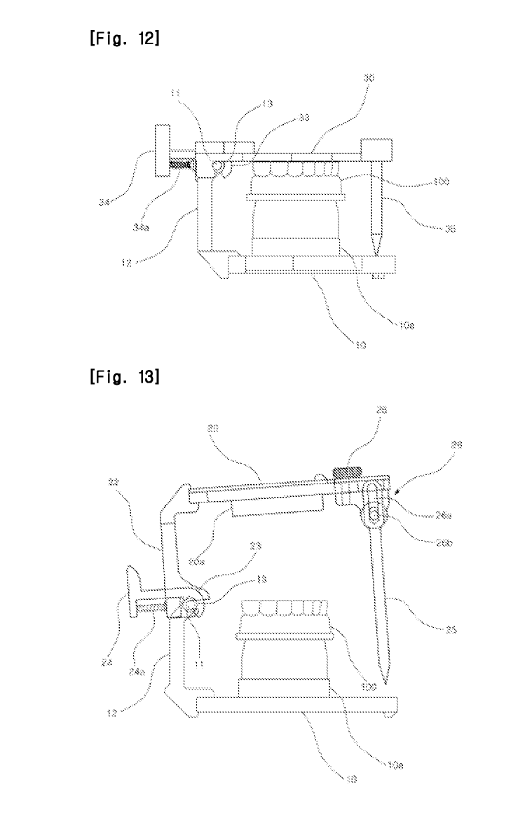

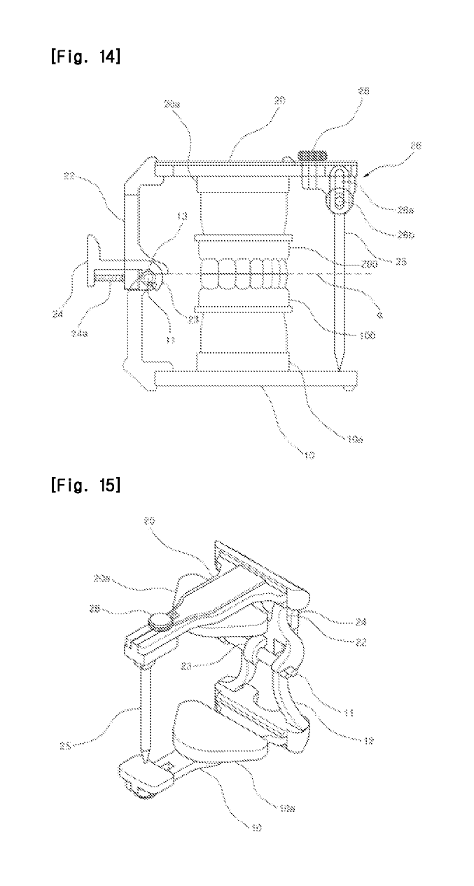

When the lower jaw model 100 is positioned as shown in FIGS. 10 and 11, the in-place articulating on the articulating plane surface can be made possible using the jig 30. It is preferred that the jig 30 has the same construction as the articulating structure of the upper jaw mounting plate 20.

In other words, the jig 30 becomes detachable from the shaft 13 by means of the hook 33 formed at the center between the support parts 32 as the support part 32 with a mounting groove 31 is protruded from a rear lower side, and the rotary shaft 11 comes into close contact with the mounting groove 31. At this time, a push switch 34 is disposed at a rear side of the hook 33, and the push switch 34 has a recovery force with the aid of the spring 34a, thus becoming detachable in one touch way.

Slope surfaces 33b and 32b are formed at the front end portion of the hook 33 and the lower end portion of the support part 32. When articulating the jig 30, the slope surface 33b of the hook 33 fits as it slides along an upper surface of the shaft 13, and the slope surface 31b of the support part 32 fits as it slides along the upper surface of the rotary shaft 11 and is pressurized, so the forced fits are made possible, and the assembling procedure becomes easier.

In addition, on the contrary, when it is needed to separate the jig 30 from the lower jaw mounting plate 10, the push switch 34 is pushed, and the pusher 33a protruded from the inner side of the hook 33 pushes forward the shaft 13, thus releasing the coupled state of the support part 32, so the upward disconnection is made in a simple way.

At this time, the jig 30 has a vertical pin 35 at a front side of it, so the coupled state of the jig 30 can be maintained, and the articulating plane surface (α) of the lower jaw model 100 is set, and the lower jaw model 100 is made to come into close contact with the lower side of the jig 30, thus positioning in place.

Since the lower surface itself of the jig 30 has an articulating plane surface (α), the lower jaw model 100 can be made to come into close contact with the lower side of the jig 30 without using a certain means such as an eye measurement, a rubber string, a laser, etc., so the lower jaw model 100 can be positioned at an accurate portion of the articulating plane surface (α).

In case that a patient has no teeth when using the articulator, the work is performed so that the articulating plane surface keeps horizontal; however in case that a patient has teeth, the work is conducted with the articulating plane surface having a slope of −2°. The jig 30 can used for both the patient with teeth or without teeth in such a way to set the height of the vertical pin 35 formed at the jig 30.

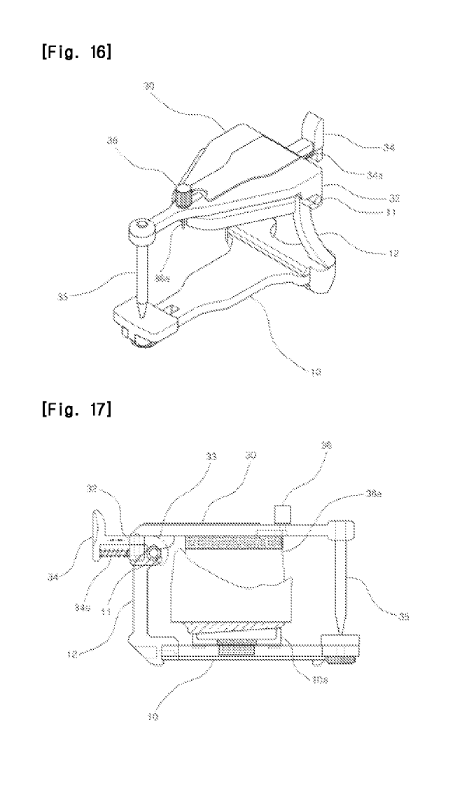

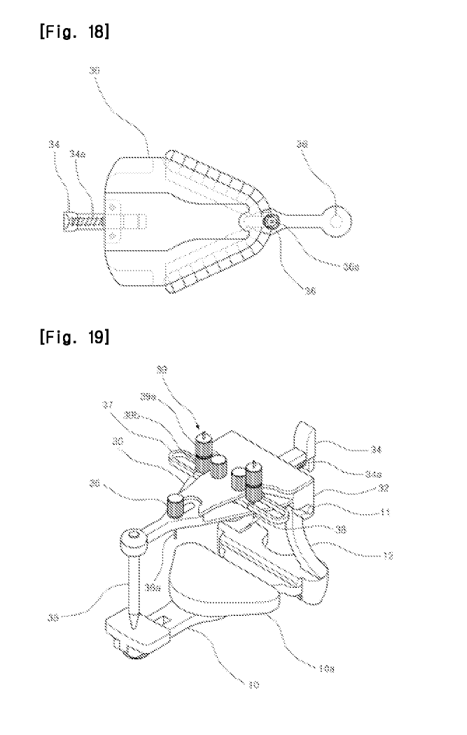

As shown in FIGS. 16 to 18, the jig 30 can be configured to fix the incisions of the lower jaw model as an incision positioning pin 36a is formed so that it can slide forward and backward by means of a position motion handle 36, and as shown in FIG. 19, at the rear side is disposed a molar positioning pin 38. As the molar positioning pin 38 moves left and right by means of a transfer handle 39, it can move upward or downward. As the molar positioning pin 38 is pressurized on the upper surface of the molar, the lower jaw model can be tightly fixed.

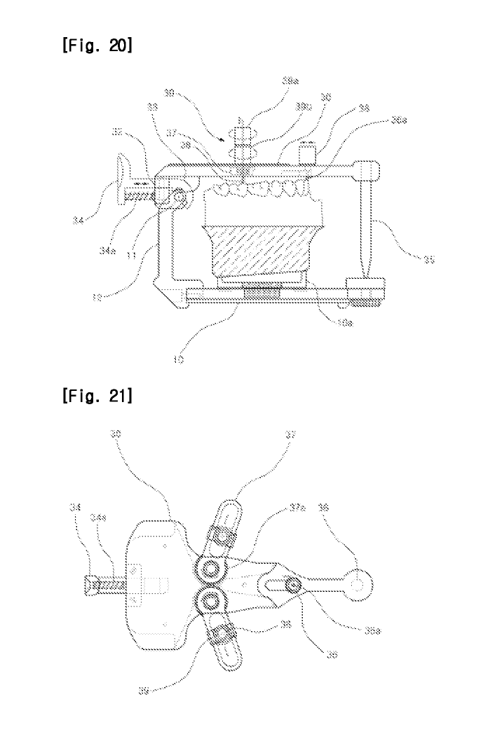

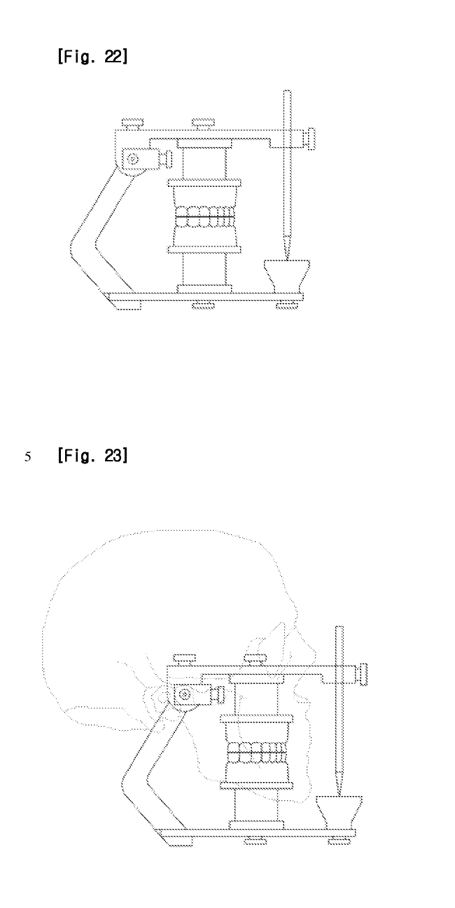

At this time, as shown in FIG. 20, the transfer handle 39 is formed in a two-tier structure in the upper and lower sides, so the upper and lower height can be adjusted as the molar positioning pin 38 ascends and descends. As shown in FIG. 21, with the lower handle 39b, the molar positioning pin 38 can be adjusted left and right for the purpose of adjusting the molar distance of left and right sides.

For the sake of that, the lower side handle 39b is coupled with a rack gear formed at the molar guide 37, and as the lower side handle 39b rotates, the molar positioning pin 38 slightly moves left and right depending on the rack gear, so the position of the molar positioning pin 38 can be adjusted depending on the size of the jaw joint.

The left and right sides of the molar guide 37 are configured to be coupled with each other. When one side angle is adjusted, the other side symmetrically moves, so setting the position of a molar tooth becomes easier, and as a pressurizing packing 37a is formed on an outer surface of the rotating shaft of the molar guide 37 of both sides, so the pressurizing packings 37a pressurizes themselves, and it moves horizontally.

The force applied between the pressurizing packings 37a can be adjusted by adjusting the thickness of the pressurizing packings 37a. It is preferred that in a state that they are pressurized and made closer to themselves by constant force, when one molar guide 37 is held, and the angle of the other molar guide 37 is adjusted as they are symmetrically movable, they becomes closer enough to facilitate them to move individually.

1. An articulator, comprising:
a lower jaw mounting plate 10 configured to mount a lower jaw model 100; and
an upper jaw mounting plate 20 configured to mount an upper jaw model 200, with the lower jaw mounting plate 10 and the upper jaw mounting plate 20 being folded upward and downward by means of a rotary shaft 11, and the columns 12 and 22 formed at the rear sides of the lower jaw mounting plate 10 and the upper jaw mounting plate 20 have the same lengths, and the rotary shaft 11 is formed on an extension line of an articulating plane surface (α), and the lower jaw mounting plate 10 and the upper jaw mounting plate 20 operate symmetrically upward and downward about the rotary shaft 11, and when the lower jaw model 100 and the upper jaw model 200 are folded upward and downward, the tangent line (β) of the rotation motion is applied on the articulating plane surface in a vertical direction.

2. An articulator of claim 1, wherein the lower jaw mounting plate 10 is configured in such a way that a shaft 13 is formed at the top of the column 12 formed at a rear side, and a rotary shaft 11 is protruded from both sides, and the upper jaw mounting plate 20 is configured in such a way that a laid-down channel shaped rotation support part 21 with an inner insertion groove 21a is formed at a lower side of the column 22 and is axially engaged to the rotary shaft 11 and is detachable from the shaft 13 by means of a hook 23 formed at a center between the rotation support parts 21.

3. An articulator of claim 2, where the hook 23 elastically operates and has a recovery force as it has a push switch 24 at a rear side by means of a spring 24a and becomes detachable in one touch way, and slope surfaces 23b and 21b are formed at a front end portion of the hook 23 and a lower end portion of the rotation support part 21 for thereby being pressurized and fitting.

4. An articulator of claim 3, wherein a pusher 23a is protruded downward from an engaged inner side of the hook 23, and when a push switch 24 is pushed, the shaft 13 is pushed forward, so it can disconnect easily.

5. An articulator of claim 3, where the rotation support part 21 has a slope 21c in an outward direction at an inner end portion of the inner insertion groove 21a, so the rotary shaft is not interfered when distorting left and right the upper jaw mounting plate 20.

6. An articulator of claim 3, wherein the rotation support part 21 is configured for an upper surface of the inner insertion groove 21a to have a slope angle of −2°, so when the upper jaw mounting plate 20 is distorted left and right, it moves with a degree closer to a physiological movement of teeth, so an articulation measurement can be accurately performed.

7. An articulator of claim 1 wherein the lower jaw mounting plate 10 has a jig 30 for adjusting a horizontal state of the lower jaw model 100, so the lower jaw model can be accurately positioned on the articulating plane surface while maintaining a horizontal state with a vertical pin 35 formed at a front side of the jig 30.

8. An articulator of claim 7, wherein the lower jaw mounting plate 10 is configured in such a way that a shaft 13 is formed at the top of the column 12 formed at a rear side, and a rotary shaft 11 is protruded from both sides, and the jig 30 is configured in such a way that a support part 32 with a mounting groove 31 at a rear lower side is protruded, and the rotary shaft 11 is closely mounted on the mounting groove 31 and is detachable from the shaft 13 by means of a hook 33 formed at a center between the support parts 32.

9. An articulator of claim 7, wherein the jig 30 defines an incisions positioning pin 36a which slides forward and backward by means of the position motion handle 36, thus fixing an incisions of a low jaw model.

10. An articulator of claim 9, wherein the jig 30 is configured in such a way that a molar guide 37 is formed at a rear side of the incisions positioning pin 36a, which defines the molar positioning pin 38 and the transfer handle 39, and the molar positioning pin 38 is movable left and right by means of the transfer handle 39 for the purpose of upward and downward motions for thereby setting the position of the molar positioning pin 38.

11. An articulator of claim 10, wherein the molar guide 37 is coupled in a state that the pressurizing packings 37a come into close contact with an outer surface of the rotary shaft and operate symmetrically in left and right sides, so even when a force exceeding a close contact force generates, the rotation angle can be individually adjusted.

12. An articulator of claim 1, wherein a guide pin 25 is formed at a front side of the upper jaw mounting plate 20, so the horizontal state of the upper jaw mounting plate 20 can be supported, and an adjusting means 26 is formed at the top of the guide pin 25, so the guide pin 25 can vertically move upward and downward thus adjusting an angle and the height of the upper jaw mounting plate 20.

13. An articulator of claim 12, wherein the adjusting means 26 has a prolonged hole 26a at the top of the guide pin 25, and the prolonged hole 26a is engaged to the fixing shaft 26b and moves vertically, thus adjusting the angle, and the adjusting means 26 is coupled to the guide rail 27 of the front side of the upper jaw mounting plate 20 in a rail structure for thereby sliding in forward and backward directions.
